(19) United States
(12) Patent Application Publication
(10) Pub. No.: US 2010/0173092 A1
(43) Pub. Date: Jul. 8, 2010

(54) ADHESIVE MASKING TAPES AND METHOD FOR COATING AND/OR REPAIRING COMPONENTS

(75) Inventor: Wolfgang Wachter, Munich (DE)

Correspondence Address: HOWISON & ARNOTT, L.L.P, P.O. BOX 741715, DALLAS, TX, 75374-1715, US

(73) Assignee: MTU AERO ENGINES, GMBH, Munich (DE)

(21) Appl. No.: 12/602,078

(22) PCT Filed: May 15, 2008
(86) PCT No.: PCT/DE2008/000840

§ 371 Date: Nov. 25, 2009

(30) Foreign Application Priority Data
Jun. 5, 2007 (DE) 10 2007 026 271.1

(51) Int. Cl. B05D 1/32; C09J 7/02; B05D 1/08

(52) U.S. Cl. 427/448; 428/354

(57) ABSTRACT

A masking tape, particularly for use with thermal spraying methods, comprises a tape- and/or strip-like base layer, the base layer including silicone and a glass fiber and/or glass fabric insert, an adhesive layer disposed on the base layer, and at least two scale-like or lamellar elements made of metal or a metal alloy that are attached to the base layer on the surface located opposite the adhesive layer. Another masking tape, particularly for use with thermal spraying methods, comprises a tape- and/or strip-like base and adhesive layer, the base and adhesive layer comprising a glass fiber and/or glass fabric tape and a silicone adhesive, and at least two scale-like or lamellar elements made of metal or a metal alloy that are attached to a surface of the base and adhesive layer. Further, a method of coating and/or repairing components, in particular, turbine or power unit components, uses the aforesaid masking tape and a thermal spraying method.

### CROSS-REFERENCE TO RELATED APPLICATIONS

This application is a U.S. National Phase application submitted under 35 U.S.C. §371 of Patent Cooperation Treaty application serial no. PCT/DE2008/000840, filed 15 May 2008, and entitled ADHESIVE MASKING TAPES AND METHOD FOR COATING AND/OR REPAIRING COMPONENTS, which application claims priority to German patent application serial no. DE 10 2007 026 271.1, filed 5 Jun. 2007, and entitled ABDECKKLEBEDÄNDER UND VERFAHREN ZUM BECHICHTEN UND/ODER AUSBESSERN VON BAUTEILEN, the specifications of which are incorporated herein by reference in their entireties.

### TECHNICAL FIELD

The invention relates to a masking tape, in particular for use in thermal spraying methods, with a tape- or strip-like base layer and an adhesive layer, as well as a masking tape, in particular for use in thermal spraying methods, with a tape- or strip-like base and adhesive layer. The invention further relates to a method of coating and/or repairing components, in particular, turbine or power unit components in a thermal spray process using a masking tape.

### BACKGROUND

The term “thermal spraying” covers completely different spraying methods such as plasma spraying, electric-arc spraying, laser spraying, flame-spraying. See DIN 32530 for details about the various spraying methods. Other processes to be mentioned here include high-speed flame spraying, detonation spraying, and cold gas spraying.

The various spraying methods covered by the term “thermal spraying” have in common that a material to be applied to an object is fed into an apparatus for thermal spraying where thermal and kinetic energy are supplied to it. In other words, the raw material, typically a multicomponent powder, is heated so that it melts, in which process it forms microscopically small beads. A beam that conducts the material onto an object to be coated is created using a gas that may be ionized (in plasma spraying).

Thermal spraying methods are used particularly in power unit construction. Thermal spraying methods are used both in the production of new power units and in repairing power units. Thermally sprayed coatings are used in power unit construction to form coatings for corrosion or oxidation protection, erosion protection, dimension adjustment, wear protection, or titanium fire protection. Coatings produced in this way may also form strip coatings or heat-insulation coatings. In addition to the advantages of thermal spraying methods, there also is the disadvantage that components not to be processed have to be protected from erosion phenomena and undesirable excessive heat using expensive masking means such as sheet-metal masks or plastic silicone compounds. This is why these methods cannot be applied in a fast and simple manner. Furthermore, known masking tapes that can generally be applied fast and easily cannot be used since they would be eroded off during thermal spraying. It is therefore the object to provide masking tapes of the type mentioned at the outset that are suited for use with thermal spraying.

It is another object to provide a method for coating and/or repairing components, in particular, turbine or power unit components, using a thermal spraying method that can be performed simply and fast.

### SUMMARY

The aforesaid objects are achieved by masking tapes as disclosed and claimed herein as well as a method for coating and/or repairing of components as disclosed and claimed herein.

Advantageous embodiments are described herein and in the respective dependent claims.

A masking tape, in particular for use with thermal spraying methods, includes a tape- or strip-like base layer and an adhesive layer, said base layer consisting of silicone and a glass fiber and/or glass fabric insert and additionally having at least two scale-like or lamellar elements made of metal or a metal alloy attached to the base layer on the surface of the masking tape opposite to the adhesive layer. Such a design according to the invention of the masking tape permits its use with thermal spraying methods. The base layer made of silicone and a glass fiber and/or glass fabric insert ensures flexibility of the masking tape on the one hand and temperature stability on the other. The masking tape according to the invention can be applied fast and easily. The masking tape is protected against erosion by the scale-like or lamellar elements of metal or a metal alloy that are attached to its surface, i.e. in the direction of the material beam. The scale-like or lamellar elements also dissipate heat. Use of silicone in the base layer also ensures that the masking tape is elastic enough to absorb the forces from the rigid scale-like or lamellar elements. Furthermore, the masking tape according to the invention has the advantage that the masking tape can easily be split between sections due to the way the scale-like or lamellar elements are arranged; this structure also provides the required flexibility of the masking tape. According to one embodiment of the masking tape according to the invention, the adhesive layer can be formed by a silicone adhesive. The scale-like or lamellar elements can be made of steel, in particular of sheet steel.

In other advantageous embodiments of the masking tape, the scale-like or lamellar elements are arranged so that they at least partially overlap. This prevents spray or material particles from penetrating in the direction of the scales and damaging the base layer. The scale-like or lamellar elements may also be magnetized, the individual elements being arranged in such a way that the north pole of one element abuts against or rests upon the south pole of the adjacent element. This measure also contributes to the individual elements forming a relatively firm and tight protective layer against ingression of the spray particles mentioned and counteracting potential destruction of the base layer. It is further possible that the scale-like or lamellar elements have a square, rectangular, round, semicircular, rhombic, elliptical, and/or semielliptical shape. Other shapes are conceivable. In addition, the elements may be flat and/or have a profile.

Alternatively or in addition, the metal elements may be arranged in a non-overlapping manner, particularly in a tiled arrangement. The elements may be glued on or attached in another manner.

In another advantageous embodiment of the masking tape, the scale-like or lamellar elements at the end facing the base layer comprise at least one fastening structure for attachment to the base layer. The fastening structure can be provided in the form of a hook or a loop. Other fastening structures are conceivable.

Another masking tape, particularly for use with thermal spraying methods, includes a tape- and/or strip-like base and adhesive layer, wherein said base and adhesive layer consists of a glass fiber tape or glass fabric tape and a silicone adhesive and wherein at least two scale-like or lamellar elements made of metal or a metal alloy are attached to the base layer on one surface of the masking tape. Such a design of the masking tape permits its use with thermal spraying methods. The base and adhesive layer made of a glass fiber and/or glass fabric tape and a silicone adhesive ensure flexibility of the masking tape on the one hand and temperature stability on the other. The masking tape can be applied fast and easily. The masking tape is protected against erosion by the scale-like or lamellar elements of metal or a metal alloy that are attached to its surface, i.e. in the direction of the material beam. The scale-like or lamellar elements also dissipate heat. Use of silicone in the base layer also ensures that the masking tape is elastic enough to absorb the forces from the rigid scale-like or lamellar elements. Furthermore, the masking tape has the advantage that the masking tape can easily be split between sections due to the way the scale-like or lamellar elements are arranged; this structure also provides the required flexibility of the masking tape. According to one embodiment of the masking tape, the scale-like or lamellar elements can be made of steel, in particular of sheet steel.

In other advantageous embodiments of the second masking tape, the scale-like or lamellar elements are arranged so that they at least partially overlap. This prevents spray or material particles from penetrating in the direction of the scales and damaging the base layer. The scale-like or lamellar elements may also be magnetized, the individual elements being arranged in such a way that the north pole of one element abuts against or rests upon the south pole of the adjacent element. This measure also contributes to the individual elements' forming a relatively firm and tight protective layer against ingression of the spray particles mentioned and counteracting potential destruction of the base layer. It is further possible that the scale-like or lamellar elements have a square, rectangular, round, semicircular, rhombic, elliptical, and/or semielliptical shape. Other shapes are conceivable. In addition, the elements may be flat and/or have a profile.

In another advantageous embodiment of the second masking tape, the scale-like or lamellar elements at the end facing the base layer comprise at least one fastening structure for attachment to the base layer. The fastening structure can be provided in the form of a hook or a loop. Other fastening structures are conceivable.

A method for coating and/or repairing components, in particular turbine and power unit components, includes a thermal spraying method in which a masking tape as described above is used and which includes the following steps: a) delivery of the component to be processed; b) masking at least the sections surrounding the areas to be processed with the masking tape; and c) coating of the unmasked sections or sections to be processed with the coating material to be applied using the thermal spraying method. The method ensures simple and fast execution of thermal spraying methods when coating and/or repairing components. In particular the process of masking the sections not to be processed is simplified using the masking tape and made considerably faster.

Surface roughening by blasting may be performed prior to masking.

In advantageous embodiments of the method, the thermal spraying method is a plasma spraying, electric-arc spraying, detonation spraying, cold gas spraying, flame spraying, or high-speed flame spraying method. The coating material can be selected so that it serves to form a corrosion, oxidation, erosion, wear, and/or titanium fire protection coating and/or a coating for dimension adjustment or heat insulation coating or strip coating. For example, the coating material can be selected from the group of MCrAlY alloys with M=Ni and/or Co. In another example, the coating material forms at least one of a WC/Co, NiAl, NiCrAl and a wear protection coating containing MoSi. In another example, the coating material forms another carbidic coating.

### BRIEF DESCRIPTION OF THE DRAWINGS

The embodiments shown in the following figures disclose other details, characteristics, and advantages. Wherein:

FIG. 1 shows a diagrammatic view of two masking tapes; and

FIG. 2 shows a diagrammatic view of two lamellar elements of a masking tape according to another embodiment.

### DETAILED DESCRIPTION

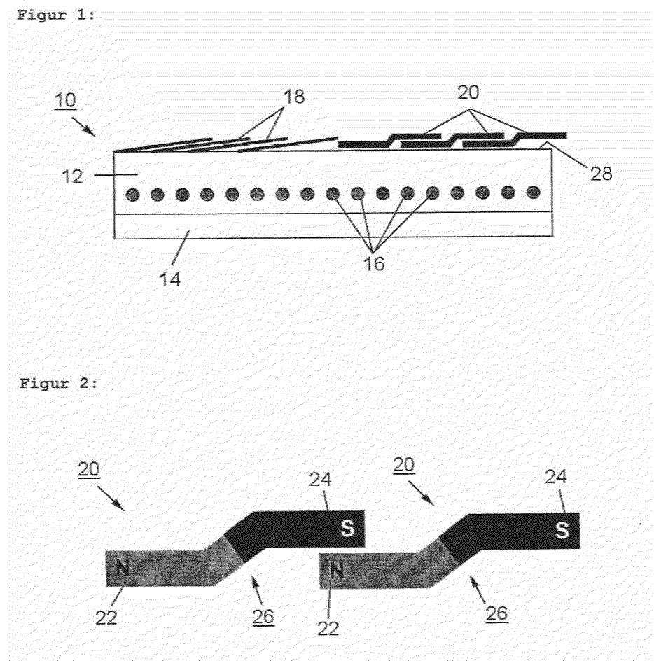

FIG. 1 shows a diagrammatic view of two masking tapes 10. The left half of FIG. 1 shows a masking tape 10 with flat scale-like or lamellar elements 18. The right half of FIG. 1 shows a masking tape 10 with profiled scale-like or lamellar elements 20. Apart from these differences described here, the masking tapes 10 are identical in structure. The description below therefore refers to both embodiments of the masking tape 10.

One can see that the masking tape 10 comprises a tape- or strip-like base layer 12 and an adhesive layer 14. The base layer 12 consists of silicone and a glass fiber and/or glass fabric insert 16. The adhesive layer 14 consists of a silicone layer in the embodiments presented here. The adhesive layer 14 is used to place the masking tape 10 onto the component to be processed. One can further see that a multitude of the scale-like or lamellar elements 18, 20 is arranged on the surface 28 of the masking tape 10 that is located opposite the adhesive layer 14. The elements 18, 20 consist of metal or a metal alloy and are attached to the base layer 12. In the embodiment shown, the scale-like or lamellar elements 18, 20 consist of steel or sheet steel plates that overlap. The elements 18, 20 may also be tiled. In such an embodiment that is not represented here, there will be flexibility in two dimensions. Improved erosion protection is achieved with the overlapping scale-like or lamellar elements 18, 20 shown here. Furthermore, the elements 18, 20 may be of a strip-like design wherein, according to yet another embodiment not shown here, the length of these strips matches the width of the masking tape 10. This results in flexibility in just one dimension but also in increased stability of the masking tape 10.

FIG. 2 shows a diagrammatic view of two scale-like or lamellar elements 20 of the masking tape 10 according to yet another embodiment. One can see that the elements 20 have a profiled design and each comprise a step 26. One can further see that the elements 20 are magnetized, and the individual elements 20 are arranged in such a way that the south pole 24 of a first element 20 always abuts against the north pole 22 of the next element 20 or—as shown in the embodiment—rests on top of it. This arrangement lets the elements 20 form a relatively closed protective layer that prevents spray particles from penetrating in the direction of the scales and potentially destroying the base layer 12.

1-21. (canceled)

22. A masking tape comprising:
a base layer having one of a tape-like and a strip-like configuration and comprising silicone and an insert, the insert being at least one of a glass fiber and a glass fabric;
an adhesive layer disposed on one surface of the base layer; and
at least two elements having one of a scale-like and a lamellar configuration and made of one of a metal and a metal alloy attached to the base layer on the surface located opposite the adhesive layer.

23. A masking tape according to claim 22, wherein the adhesive layer is formed of a silicone adhesive.

24. A masking tape according to claim 22, wherein the scale-like or lamellar elements are formed of steel.

25. A masking tape according to claim 22, wherein the scale-like or lamellar elements are arranged in such a way that they at least partially overlap one another.

26. A masking tape according to claim 22, wherein the scale-like or lamellar elements are tiled.

27. A masking tape according to claim 22, wherein the scale-like or lamellar elements have a shape that is at least one of square, rectangular, hexagonal, round, semicircular, rhombic, elliptical and semielliptical.

28. A masking tape according claim 22, wherein the scale-like or lamellar elements are one of flat and profiled.

29. A masking tape according to claim 22, wherein the scale-like or lamellar elements are magnetized to create a north pole and a south pole on each individual element, and the individual elements are arranged so that the south pole of one element abuts against or rests upon the north pole of an adjacent element.

30. A masking tape according to claim 22, wherein the scale-like or lamellar elements further include at least one fastening structure for attachment to the base layer.

31. A masking tape comprising:
a base and adhesive layer having one of a tape-like and a strip-like configuration and comprising a tape of one of a glass fiber and a glass fabric and a silicone adhesive; and
at least two elements having one of a scale-like and a lamellar configuration and made of one of a metal and a metal alloy attached a surface of the base and adhesive layer.

32. A masking tape according to claim 31, wherein the scale-like or lamellar elements are formed of steel.

33. A masking tape according to claim 31, wherein the scale-like or lamellar elements are arranged in such a way that they at least partially overlap one another.

34. A masking tape according to claim 31, wherein the scale-like or lamellar elements are arranged in a tiled configuration.

35. A masking tape according to claim 31, wherein the scale-like or lamellar elements have a shape that is at least one of square, rectangular, hexagonal, round, semicircular, rhombic, elliptical and semielliptical.

36. A masking tape according to claim 31, wherein the scale-like or lamellar elements are one of flat and profiled.

37. A masking tape according to claim 31, wherein the scale-like or lamellar elements are magnetized to create a north pole and a south pole on each individual element, and the individual elements are arranged so that the south pole of one element abuts against or rests upon the north pole of an adjacent element.

38. A masking tape according to claim 31, wherein the scale-like or lamellar elements further include at least one fastening structure for attachment to the base and adhesive layer.

39. A method for coating and/or repairing a component using thermal spraying, comprising the following steps:
a) providing a component having a defined area to be thermally sprayed;
b) providing a masking tape including
a base and adhesive layer having one of a tape-like and a strip-like configuration and comprising a tape of one of a glass fiber and a glass fabric and a silicone adhesive; and
at least two elements having one of a scale-like and a lamellar configuration and made of one of a metal and a metal alloy attached a surface of the base and adhesive layer;
c) masking at least some sections of the component surrounding the defined area with the masking tape; and
d) thermally spraying the defined area of the component.

40. A method according to claim 39, wherein the thermal spraying includes at least one of plasma spraying, electric-arc spraying, detonation spraying, cold gas spraying, flame spraying and high-speed flame spraying.

41. A method according to claim 39, wherein the thermal spraying applies a coating material to the defined area of the component, and the coating material is selected for forming at least one of a corrosion, oxidation, wear and dimension-adjusting coating.

42. A method according claim 41, wherein the coating material comprises at least one of the following:
a) a material selected from the group of MCrAlY alloys with M=at least one of Ni and Co;
b) a material that forms at least one of a WC/Co, NiAl, NiCrAl and a wear protection coating containing MoSi; and
c) a material that forms another carbidic coating.
